(19) United States
(12) Patent Application Publication
(10) Pub. No.: US 2023/0254138 A1
(43) Pub. Date: Aug. 10, 2023

(54) SECURE CONFIGURABLE LOGIC DEVICE (sCLD)

(71) Applicant: R3 Ltd., London (GB)

(72) Inventor: Rui Almeida, London (GB)

(21) Appl. No.: 17/666,378

(22) Filed: Feb. 7, 2022

(51) Int. Cl. H04L 9/08; H04L 9/30

(52) U.S. Cl. CPC H04L 9/088; H04L 9/30

(57) ABSTRACT

A method performed by a processor with a trusted execution environment (TEE) and connected to configurable logic device (CLD). The TEE sends to the CLD one or more encrypted messages to provide a session key and configuration data for configuring the CLD. The message with the session key is encrypted with CLD public key of a CLD public/private keypair of the CLD. The CLD receives the one or more encrypted messages. The CLD decrypts the one or more encrypted messages. The CLD message with the session key is decrypted using a CLD private key of the CLD public/private keypair. The CLD stores the session key and configures the CLD based on the configuration data of a CLD message.

### BACKGROUND

In the 1980s, field-programmable gate arrays (FPGAs) were designed with configurable logic blocks (CLBs), lookup tables (LUTs), internal interconnects, and input/output (I/O) interconnects that could be configured to performed various computational functions. The CLBs provided logic functions such as XOR and AND. A developer of a computing system, embedded system, and so on could use an FPGA in place of using specially designed discrete logic. The configuration of an FPGA was fixed in the sense that it was performed by a developer of a system and could not be later changed, at least not without shining an ultra-violet light on the FPGA.

Over time, FPGAs were developed that included higher-level capabilities such as digital signal processors (DSPs), computational capabilities (e.g., multiplier), and high-speed memory access controllers, and so on. Recently developed FPGAs even include embedded processors, such as processor cores that provide central processing unit (CPU) functions. These FPGAs can be programmed (configured) dynamically when a program wants an FPGA to perform different functions at different times. For example, an FPGA can be programmed to support training a neural network model or solving a partial differential equation. The configuration of a FPGA may be specified using a hardware description language. Graphic processing units (GPUs) have similarly evolved over time to be programmable and to provide general computational capabilities in addition to graphics processing. Complex programmable logic devices (CPLDs) similarly can be programmed. Devices that can be dynamically configured or programmed, such as FPGAs, GPUs, and CPLDs, are referred to as configurable logic devices (CLDs).

CLDs are being used extensively in a variety of applications. For example, they are used to speed up search capabilities, to index data sets, to train machine learning models, to provide complex mathematical processing (e.g., blockchain mining and financial analyses), to process transactions, and so on. Currently, however, a program using a CLD needs to rely on the host computing system to ensure that a CLD is configured correctly. A malicious or malfunctioning host computing system may provide an incorrect configuration that can lead to disastrous consequences, such as incorrectly trained machine learning models, theft of financial or medical information, and so on.

Some computer architectures provide a Trusted Execution Environment (TEE) for execution of trusted code (an application program) in a tamper-proof environment. The trusted code is stored as an “enclave.” The trusted code and its initial data are stored in memory in encrypted form and decrypted only when retrieved and stored in protected memory (EPC) for execution or use. Untrusted code, which is a code other than the trusted code, cannot inspect or interfere with the execution of the trusted code (at least without the permission of the trusted code). The TEE thus protects data at rest (within the TEE), in motion (between the TEE and storage), and during computation (within the TEE). The term “application” refers to a program that may include trusted code and untrusted code. The term “client” refers to code that interacts with the trusted code. The Intel Software Guard Extensions (SGX) and the ARM TrustZone are examples of a TEE. In the following, a TEE is described primarily in the context of SGX.

An enclave includes a trusted code and its data and a certificate of the author of the enclave. The certificate is referred to as an Enclave Signature (SIGSTRUCT). The enclave signature includes an enclave measurement, the author’s public key, a Security Version Number (ISVSVN) of the enclave, and a Product ID (ISVPRODID) of the enclave. The enclave signature is signed using the author’s private key. The enclave measurement is a hash of the trusted code and its initial data. When the code is loaded into protected memory (EPC), the CPU calculates a measurement and stores it in an MRENCLAVE register. If the calculated measurement is not equal to the enclave measurement, the CPU will not allow the enclave to be initialized within the TEE. After the enclave is initialized, the CPU stores a hash of the author’s public key in a MRSIGNER register as an identifier of the author. The ISVSVN specifies the security level of the enclave. The ISVPRODID identifies the product the enclave represents. The CPU records both the ISVSVN and ISVPRODID.

A client that is to interact with an enclave (that has been initialized) would typically require the TEE to “attest” to the trusted code and data of the enclave. To provide an attestation to a client that may be executing on a platform that is different from the platform of the CPU that is executing the enclave (referred to as “remote” attestation), the TEE generates a “report” that includes the measurement (MRENCLAVE), hash of the author’s public key (MRSIGNER), attributes of the enclave, and user data of the enclave. The report is passed to a quoting enclave (QE) to verify and sign the report. When verified, the QE generates a “quote” the includes the report and a signature of the TEE. The quote is then sent to the client.

Upon receiving a quote, the client can verify the signature and if verified, ensure that the report represents the trusted code that the client expects. The signature may be based on an Enhanced Privacy ID (EPID), in which different TEE have different private keys, but signatures based on those private keys can be verified using the same public key. The client may invoke the services of an EPID verification service to verify a signature on a quote. Such an attestation is referred to as a “remote attestation.”

An enclave that is to interact with another enclave that is executing on the same platform may want the other enclave to attest to its trusted code and data. In such a case, a simplified version of attestation can be used (referred to as “local” attestation). To initiate an attestation, the requesting enclave can send its MRENCLAVE measurement to an attesting enclave. The attesting enclave requests the CPU to generate a report destined to the requesting enclave identified by the MRENCLAVE measurement that it received and sends the report to the requesting enclave. The requesting enclave then asks the CPU to verify the report. The attesting enclave may request the requesting enclave to provide an attestation to affect a mutual attestation.

A TEE provides support for an enclave to encrypt data that is to be stored outside of the TEE and to decrypt the encrypted data when it is later retrieved into the TEE. This encrypting and decrypting is referred to as “sealing” and “unsealing.” The TEE generates an encryption key and a decryption key based on a “fused key” that is not known outside of the hardware. The fused key is fused into the CPU hardware during the manufacturing process of the CPU, is not known outside of the CPU not even by the manufacturer, is unique to the CPU, and cannot be accessed except by the hardware. Upon request, the CPU generates a sealing key and unsealing key (e.g., public/private keypair) that is based on the fused key and data associated with the requesting enclave. Thus, each sealing key and unsealing key is unique to the CPU because the fuse keys are unique.

The CPU can generate two types of keys based on the associated data of the enclave that is used when generating the keys. The associated data is the MRENCLAVE (referred to as “sealing to the enclave”) or the combination of the MRSIGNER, ISVSVN, and ISVPRODID (referred to as “sealing to the author”). Data that is sealed to the enclave can only be unsealed by an enclave with the same MRENCLAVE value that is executing on the same CPU (i.e., using the same fused key) that generated the sealing key. Data that is sealed to the author can be unsealed by any enclave (e.g., different trusted code) of the author that has the same ISVPRODID and the same or an earlier ISVSVN (specified in a request to seal or unseal) and that is executing on the same CPU (i.e., using the same fused key) that generated the sealing key. (Note: The CPU will not generate seal-to-the-author keys for an ISVSVN that is greater than the ISVSVN of the enclave, which allows for only backward compatibility of sealing.) The TEE provides a seal application programming interface (API) for sealing data and an unseal API for unsealing data.

### BRIEF DESCRIPTION OF THE DRAWINGS

FIG. 1 is a block diagram that illustrates the architecture of the sCLD system in some embodiments.

FIG. 2 is a flow diagram that illustrates processing of a configure FPGA component of a TEE in some embodiments.

FIG. 3 is a flow diagram that illustrates the processing of a configure component of the FPGA in some embodiments.

FIG. 4 is a flow diagram that illustrates the processing of a send FPGA message component of the TEE in some embodiments.

FIG. 5 is a flow diagram that illustrates the processing of a receive message component of the TEE in some embodiments.

FIG. 6 is a flow diagram that illustrates the processing of a send message component of the FPGA in some embodiments.

FIG. 7 is a flow diagram that illustrates the processing of a receive message component of the FPGA in some embodiments.

### DETAILED DESCRIPTION

Systems and methods are provided that support a secure execution environment (SEE) for a configurable logic device (CLD). A secure CLD (sCLD) system ensures that an sCLD is configured (e.g., programmed) in accordance with a configuration provided by an application (e.g., application program) executing in an execution environment (EE) provided by a processor (e.g., CPU). The sCLD and processor may be part of the same computing system with a hardwired connection between them. The sCLD system ensures that, if the configuration is changed, the application can detect the change. The sCLD includes an EE interface and configurable logic. An application can use the EE interface to set the configuration of the configurable logic, to send data to and receive data from the configurable logic, and to send data to and receive data from the EE. The sCLD may include a hard-coded (e.g., fused) sCLD private key of an sCLD public/private keypair. The sCLD public key of the sCLD public/private keypair may be provided to the application in different ways, such as being part of initialization data of the application or provided by a trusted program, a remote verification service (e.g., remote attestation) during initialization of the sCLD, a prior verification service (e.g., prior attestation), and so on. Prior attestation may involve a verified owner of a sCLD requesting the manufacturer of the sCLD to provide the sCLD public key. The application establishes a session with the sCLD and provides a session key to the sCLD for secure communications between the application and the sCLD. The application provides the session key in an sCLD message that is encrypted with the sCLD public key. The sCLD interface decrypts the sCLD message using the sCLD private key and stores the session key. Subsequent messages sent between the application and the sCLD can be encrypted with the session key. The session key may be a symmetric key or an asymmetric key of a session-specific public/private keypair. By encrypting the messages, the application and sCLD can verify that the messages are provided to an entity with that session key.

In some embodiments, the EE may be a trusted execution environment (TEE) such as provided by Intel SGX. When the application executes in a TEE, the application can control how and if the session key is made available outside the TEE. In the following, the sCLD is described in the context of interacting with a TEE. Also, the sCLD is described primarily as interacting with an “application.” The sCLD may interact with any type of program, such as an application program, a system program, and so on.

In some embodiments, a TEE interface of the sCLD is adapted to receive messages from and send messages to an application executing in a TEE. When a TEE receives a message with a session key, it decrypts the message using the sCLD private key. The sCLD stores the session key. The configuration data for the configurable logic may be included in the message with the session key or another message that is encrypted with the session key. When the sCLD receives the configuration data, it may reset the configurable logic and clear any data stored in memory by the configurable logic to help ensure that the session does not have access to information of a prior session. The sCLD then controls the configuration of the configurable logic based on the configuration data. The sCLD may send a confirmation message to the application so that the application can start using the now-configured configurable logic.

In some embodiments, the sCLD may be implemented on an integrated circuit that includes a processor that provides functions similar to that of a central processing unit (CPU). The processor may implement the functions of a TEE interface. The processor itself may provide a TEE similar to that provided, for example, by Intel SGX. The sCLD may include memory that is accessible by the configurable logic. The sCLD may have an interface through which an external memory is accessible. The sCLD may encrypt and decrypt data stored in the external memory using a session key. In this way, the application can provide data to and receive data from the sCLD via the external memory.

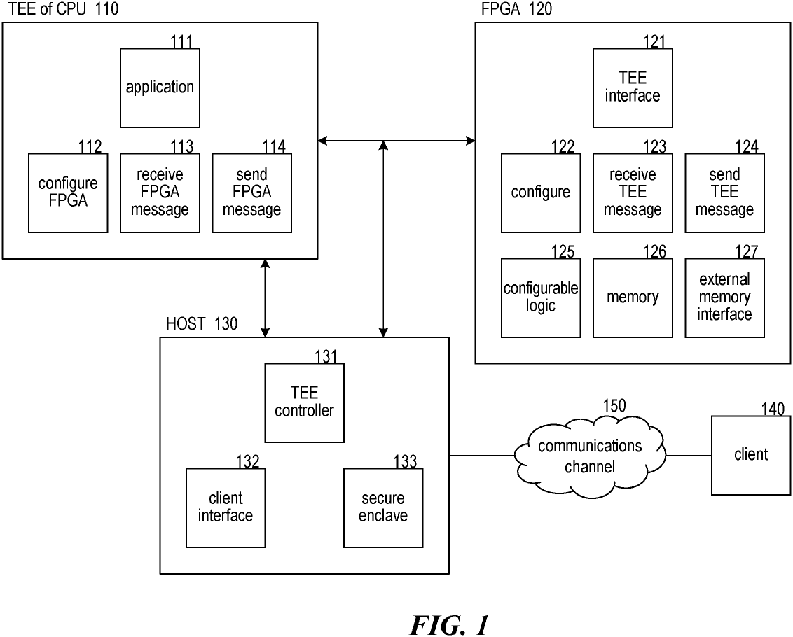

FIG. 1 is a block diagram that illustrates the architecture of the sCLD system in some embodiments. The sCLD system includes a TEE 110 of the central processing unit, an FPGA 120, a host 130, a client 140, and a communications channel 150. The TEE includes an application, a configure FPGA component 112, a receive FPGA message 113, and a send FPGA message 114. The application controls the configuring of the configurable logic of the FPGA and sending messages to and receiving messages from the FPGA. The configure FPGA component controls establishing a session with the FPGA and providing configuration data of the configurable logic. The receive FPGA message component receives messages from the FPGA and provides the messages to the application. The send FPGA component receives messages from the application and sends the messages to the FPGA.

The FPGA includes a TEE interface 121, a configure component 122, a receive TEE message component 123, a send TEE message component 124, configurable logic 125, memory 126, and an external memory interface 127. The TEE interface controls the overall interface between the TEE and the FPGA. The configure component receives a session key and configuration data from the TEE and configures the configurable logic. The receive TEE message receives messages from the TEE and processes the messages. The send TEE component sends messages to the TEE.

The host includes a TEE controller 131, a client interface 132, and a secure enclave 133. The TEE controller loads the application of the secure enclave into the TEE. The client interface interfaces with a client 140 via communications channel 150. The client is a client of the application. The client and the application may communicate via encrypted messages sent via the communications channel and the host.

The computing systems (e.g., nodes) on which the sCLD system may be implemented may include a central processing unit, input devices, output devices (e.g., display devices and speakers), storage devices (e.g., memory and disk drives), network interfaces, graphics processing units, cellular radio link interfaces, global positioning system devices, and so on. The computing systems may include desktop computers, laptops, tablets, e-readers, personal digital assistants, smartphones, gaming devices, servers, and so on. The computing systems may access computer-readable media that include computer-readable storage media (or mediums) and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the sCLD system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys. The term sCLD may be considered to refer to a CLD that is capable of being secured, for example, because of a fused public key, a secure processor, and so on or refer to a CLD that has been configured with secure configuration logic.

The sCLD system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples.

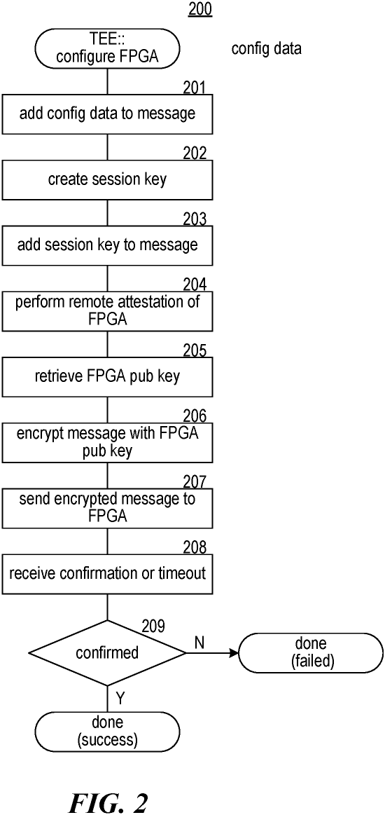

FIG. 2 is a flow diagram that illustrates processing of a configure FPGA component of a TEE in some embodiments. The configure FPGA component 200 generates a session key, retrieves an FPGA public key and configuration data, and coordinates the sending of messages to configure the configurable logic of the FPGA. In block 201, the component adds configuration data to a message to be sent to the FPGA. In block 202, the component creates a session key. In block 203, the component adds the session key to the message. In block 204, the component performs a remote attestation of the FPGA. In block 205, the component retrieves the public key of the FPGA. In block 206, the component encrypts the message with the FPGA public key. In block 207, the component sends the encrypted message to the FPGA. In block 208, the component waits to receive a confirmation or waits for a timeout. In decision block 209, if the confirmation is received, then the component returns an indication that the configuration succeeded, else the component returns an indication that the configuration failed. In some embodiments, the TEE may interface with multiple FPGAs. In such a case, the component may maintain a different session key for each FPGA.

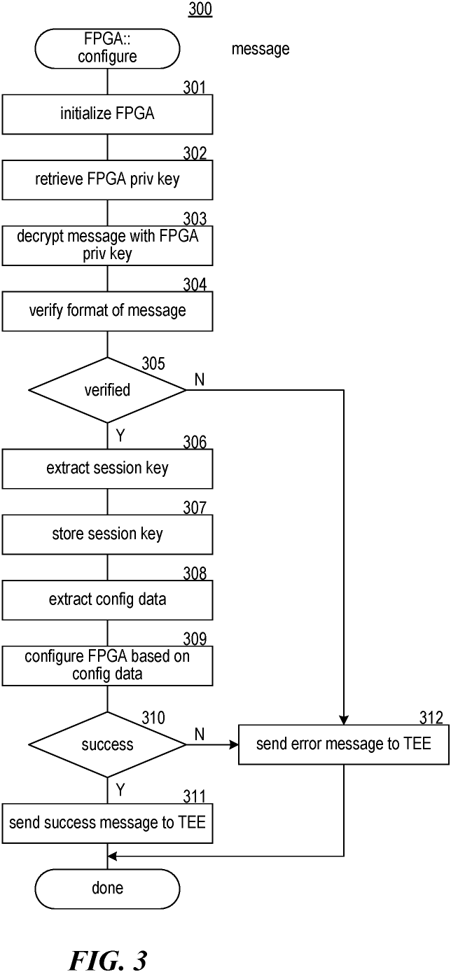

FIG. 3 is a flow diagram that illustrates the processing of a configure component of the FPGA in some embodiments. The configure component 300 receives a message and configures the configurable logic based on configuration data of the message. In block 301, the component initializes or resets the configurable logic and memory. In block 302, the component retrieves the FPGA private key. In block 303, the component decrypts the message with the FPGA private key. In block 304, the component verifies the format of the message. In decision block 305, if verified, then the component continues at block 306, else the component continues at block 312. In block 306, the component extracts the session key. In block 307, the component stores the session key for use later in the session. In block 308, the component extracts the configuration data. In block 309, the component configures the FPGA based on the configuration data. In decision block 310, if the configuration was successful, then the component continues at block 311, else the component continues at block 312. In block 311, the component sends a success message to the TEE and completes. In block 312, the component sends an error message to the TEE and completes.

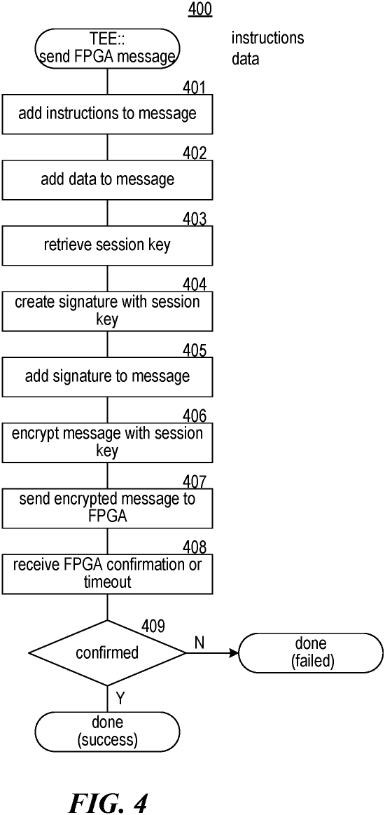

FIG. 4 is a flow diagram that illustrates the processing of a send FPGA message component of the TEE in some embodiments. The FPGA send message component 400 receives instructions and data associated with those instructions to send to the FPGA. In block 401, the component adds the instructions to the message. In block 402, the component adds the data to the message. In block 403, the component retrieves the session key. In block 404, the component may create a signature of the message with the session key. In block 405, the component adds a signature to the message. In block 406, the component encrypts the message with the session key. In block 407, the component sends the encrypted message to the FPGA. In block 408, the component receives confirmation from the FPGA or detects a timeout because the confirmation was not received. In decision block 405, if a confirmation is received, then the component completes indicating success, else the component completes indicating failure.

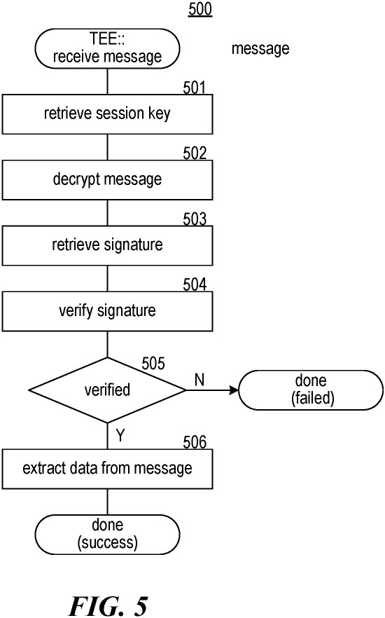

FIG. 5 is a flow diagram that illustrates the processing of a receive message component of the TEE in some embodiments. The receive message component 500 receives a message from the FPGA and provides it to the application. In block 501, the component retrieves the session key. In block 502, the component decrypts the message using the session key. In block 503, the component retrieves the signature associated with the message. In block 504, the component verifies the signature using the session key. In decision block 505, if the signature is verified, then the component continues at block 506, else the component completes indicating that the message was not sent successfully. In block 506, the component extracts the data from the decrypted message and completes indicating that the message was sent successfully.

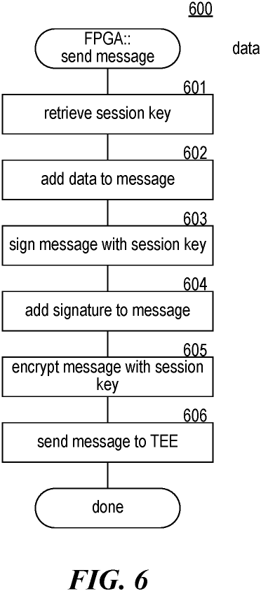

FIG. 6 is a flow diagram that illustrates the processing of a send message component of the FPGA in some embodiments. The send message component 600 receives data and sends the data in a message to the TEE. In block 601, the component retrieves the session key. In block 602, the component adds the data to a message. In block 603, the component signs the message with the session key. In block 604, the component adds a signature to the message. In block 605, the component encrypts the message with the session key. In block 606, the component sends the message to the TEE and completes.

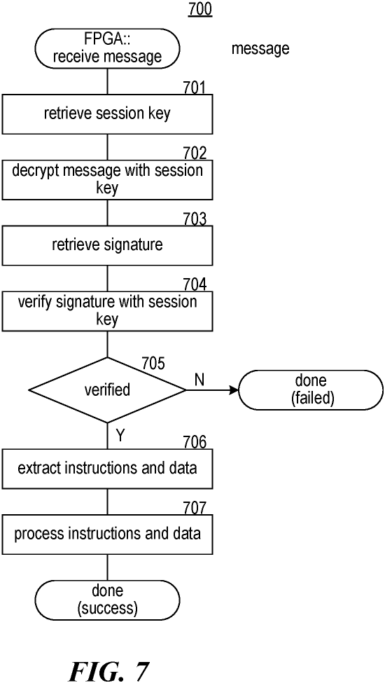

FIG. 7 is a flow diagram that illustrates the processing of a receive message component of the FPGA in some embodiments. The receive message component 700 is invoked when a message is received from a TEE. In block 701, the component retrieves the session key. In block 702, the component decrypts the message with the session key. In block 703, the component retrieves a signature. In block 704, the component verifies a signature with the session key. In decision block 705 if the signatures verified, then the component continues at block 706, else the component completes indicating failure. In block 706, the component extracts the instructions and the data. In block 707, the component processes the instructions in the data and then completes indicating success.

In some embodiments, a method performed by a computing system with an execution environment (EE) and a configurable logic device (CLD) is provided. The method, under control of the EE, sends sending to the CLD one or more encrypted CLD messages to provide a session key and configuration data for configuring the CLD. The CLD message with the session key is encrypted with the CLD public key of a CLD public/private keypair of the CLD. The method, under control of the CLD, receives receiving the one or more encrypted CLD messages, decrypts the one or more encrypted CLD messages, the CLD message with the session key being decrypted using a CLD private key of the CLD public/private keypair, stores the session key, and configures the CLD based on the CLD configuration data of a CLD message. In some embodiments, the CLD is a field-programmable gate array. In some embodiments, the CLD is a complex programmable logic device. In some embodiments, the session key is a symmetric key. In some embodiments, the session key is based on a public/private keypair. In some embodiments, the method further under control of the application, performs an attestation process to receive the CLD public key. In some embodiments, the computing system includes multiple CLDs with each CLD having a unique private key and the method further, under control of the TEE, generates a unique session key for each CLD. In some embodiments, the configuration data specifies a configuration of the CLD using a hardware description language. In some embodiments, the method further comprises, under control of the CLD, initializing the CLD prior to configuring the CLD.

In some embodiments, a configurable logic device (CLD) is provided. The CLD includes configurable logic that is configurable in accordance with configuration data received by the CLD. The CLD includes a trusted execution environment (TEE) interface is adapted to receive from a TEE a message that is encrypted with a CLD public key of a CLD public/private keypair of the CLD. The message includes a session key and configuration data. The CLD is further adapted to decrypt the message with a CLD private key of the CLD public/private keypair, to store the session key, and configure the configurable logic based on the configuration data. In some embodiments, the CLD further includes an attestation component for performing an attestation process to provide the public key to the TEE. The TEE interface is further adapted to receive from the TEE a message that includes data for the configurable logic and encrypted with the session key, decrypt the message with the session key, and provide to the configurable logic the data of the decrypted message the TEE interface is further adapted to retrieve data from the configurable logic, encrypt the data with the session key, and send to the TEE the encrypted data. In some embodiments, the CLD further includes a CLD TEE and the TEE interface is a component of the CLD TEE. In some embodiments, the CLD TEE is provided by a processor that is on the same integrated circuit as the CLD. In some embodiments, the CLD private key is embedded into the CLD during manufacturing of the CLD.

In some embodiments, 17. a computer-readable storage medium storing instructions of a secure enclave is provided. The instructions are for performing, under control of a trusted execution environment (TEE) adding to a message configurable logic device (CLD) configuration data for configuring the CLD, adding a session key to the message, encrypting the message with a CLD public key of a CLD public/private keypair of the CLD, and sending to the CLD the encrypted message. In some embodiments, the instructions are further for, under control of the TEE, performing an attestation process to receive the CLD public key. In some embodiments, the TEE interacts with multiple CLDs and the instructions are further for performing, under control of the TEE, generating a unique session key for each CLD. In some embodiments, the configuration data specifies a configuration of the CLD using a hardware description language. In some embodiments, the instructions are further for, under control of the TEE, generating a message that includes data for the configurable logic, encrypting the message with the session key, and sending the encrypted message to the CLD. In some embodiments, the instructions are further for, under control of the TEE, generating a message that include data for the configurable logic, encrypting the message with the session key; and sending the encrypted message to the CLD.

In some embodiments, a method performed by configurable logic device (CLD) is provided. The method receives from a trusted execution environment TEE a message that is encrypted with a CLD public key of a CLD public/private keypair of the CLD. The message includes a session key and configuration data. The method decrypts the message with a CLD private key of the CLD public/private keypair, stores the session key, and configures the configurable logic based on the TEE configuration instructions. In some embodiments, the method encrypts data with the session key and sending the encrypted data to the TEE. In some embodiments, the method further reads from memory data that is written to memory by code executing within the TEE and decrypting the read data with the session key. In some embodiments, the method encrypts data with the session key and writes the encrypted data to memory. In some embodiments, the method receives data from the TEE and decrypts the data with the session key. In some embodiments, the method further, after configuring the configurable logic, sends to the TEE a confirmation message that the CLD has been configured. In some embodiment, the CLD public key is obtained via a prior attestation of the CLD.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

1. A method performed by a computing system with an execution environment (EE) and a configurable logic device (CLD), the method comprising:
under control of the EE,
sending to the CLD one or more encrypted CLD messages to provide a session key and configuration data for configuring the CLD, the CLD message with the session key being encrypted with the CLD public key of a CLD public/private keypair of the CLD; and
under control of the CLD,
receiving the one or more encrypted CLD messages;
decrypting the one or more encrypted CLD messages, the CLD message with the session key being decrypted using a CLD private key of the CLD public/private keypair;
storing the session key; and
configuring the CLD based on the CLD configuration data of a CLD message.

2. The method of claim 1 wherein the CLD is a field-programmable gate array.

3. The method of claim 1 wherein the CLD is a complex programmable logic device.

4. The method of claim 1 wherein the session key is a symmetric key.

5. The method of claim 1 wherein the session key is a public/private keypair.

6. The method of claim 1 further comprising under control of the application, performing an attestation process to receive the CLD public key.

7. The method of claim 1 wherein the computing system includes multiple CLDs with each CLD having a unique private key and further comprising under control of the TEE, generating a unique session key for each CLD.

8. The method of claim 1 wherein the configuration data specifies a configuration of the CLD using a hardware description language.

9. The method of claim 1 further comprising under control of the CLD, initializing the CLD prior to configuring the CLD.

10. A configurable logic device (CLD) including:
configurable logic that is configurable in accordance with configuration data received by the CLD; and
a trusted execution environment (TEE) interface adapted to:
receive from a TEE a message that is encrypted with a CLD public key of a CLD public/private keypair of the CLD, the message including a session key and configuration data;
decrypt the message with a CLD private key of the CLD public/private keypair;
store the session key; and
configure the configurable logic based on the configuration data.

11. The CLD of claim 10 further comprising an attestation component for performing an attestation process to provide the public key to the TEE.

12. The CLD of claim 10 wherein the TEE interface is further adapted to:
receive from the TEE a message that includes data for the configurable logic and encrypted with the session key;
decrypt the message with the session key; and
provide to the configurable logic the data of the decrypted message.

13. The CLD of claim 10 wherein the TEE interface is further adapted to:
retrieve data from the configurable logic;
encrypt the data with the session key; and
send to the TEE the encrypted data.

14. The CLD of claim 10 further includes a CLD TEE and wherein the TEE interface is a component of the CLD TEE.

15. The CLD of claim 14 wherein the CLD TEE is provided by a processor that is on the same integrated circuit as the CLD.

16. The CLD of claim 10 wherein the CLD private key is embedded into the CLD during manufacturing of the CLD.

17. A computer-readable storage medium storing instructions of a secure enclave, the instructions for performing steps comprising, under control of a trusted execution environment (TEE):
adding to a message configurable logic device (CLD) configuration data for configuring the CLD;
adding a session key to the message;
encrypting the message with a CLD public key of a CLD public/private keypair of the CLD; and
sending to the CLD the encrypted message.

18. The computer-readable storage medium of claim 17 wherein the instructions further perform steps comprising: under control of the TEE, performing an attestation process to receive the CLD public key.

19. The computer-readable storage medium of claim 17 wherein the TEE interacts with multiple CLDs and wherein the instructions further perform steps comprising: under control of the TEE, generating a unique session key for each CLD.

20. The computer-readable storage medium of claim 17 wherein the configuration data specifies a configuration of the CLD using a hardware description language.

21. The computer-readable storage medium of claim 17 wherein the instructions further perform steps comprising, under control of the TEE:
generating a message that includes data for the configurable logic;
encrypting the message with the session key; and
sending the encrypted message to the CLD.

22. The computer-readable storage medium of claim 17 wherein the instructions further perform steps comprising, under control of the TEE:
generating a message that include data for the configurable logic;
encrypting the message with the session key; and
sending the encrypted message to the CLD.

23. A method performed by configurable logic device (CLD), the method comprising:
receiving from a trusted execution environment TEE a message that is encrypted with a CLD public key of a CLD public/private keypair of the CLD, the message including a session key and configuration data;
decrypting the message with a CLD private key of the CLD public/private keypair;
storing the session key; and
configuring the configurable logic based on the TEE configuration instructions.

24. The method of claim 23 further comprising encrypting data with the session key and sending the encrypted data to the TEE.

25. The method of claim 23 further comprising reading from memory data that is written to memory by code executing within the TEE and decrypting the read data with the session key.

26. The method of claim 23 further comprising encrypting data with the session key and writing the encrypted data to memory.

27. The method of claim 23 further comprising receiving data from the TEE and decrypting the data with the session key.

28. The method of claim 23 further comprising, after configuring the configurable logic, sending to the TEE a confirmation message that the CLD has been configured.

29. The method of claim 23 wherein the CLD public key is obtained via a prior attestation of the CLD.
